(19) United States
(12) Patent Application Publication
(10) Pub. No.: US 2023/0298318 A1
(43) Pub. Date: Sep. 21, 2023

(54) DEVICE CONTROL APPARATUS, DEVICE CONTROL PROGRAM, ENVIRONMENT CLASSIFICATION APPARATUS, AND ACTUATOR CONTROL APPARATUS

(71) Applicant: Nippon Telegraph and Telephone Corporation, Tokyo (JP)

(72) Inventors: Hirofumi NOGUCHI, Musashino-shi, Tokyo (JP); Misao KATAOKA, Musashino-shi, Tokyo (JP); Takuma ISODA, Musashino-shi, Tokyo (JP); Kyota HATTORI, Musashino-shi, Tokyo (JP)

(21) Appl. No.: 18/021,341

(22) PCT Filed: Aug. 18, 2020
(86) PCT No.: PCT/JP2020/031125

§ 371 Date: Feb. 14, 2023

(51) Int. Cl. G06V 10/764; G16Y 40/30; G16Y 20/10; G06V 10/776; G06V 10/70; B25J 9/16

(52) U.S. Cl. CPC G06V 10/764; G16Y 40/30; G16Y 20/10; G06V 10/776; G06V 10/87; B25J 9/1628; B25J 9/163

(57) ABSTRACT

A device control apparatus includes: a classification unit which refers to a classification table and assigns a classification label to sensor information of this time acquired from a sensor device of this time and a control unit which refers to a model table, selects, as an enhancement model, a learning model corresponding to a classification label provided by the classification unit, controls an actuator device using the enhancement model, and enhances and learns the enhancement model on the basis of the sensor information acquired from the sensor device in accordance with the control.

### TECHNICAL FIELD

The present invention relates to a device control apparatus, a device control program, an environment classification apparatus, and an actuator control apparatus.

### BACKGROUND ART

A wide variety of huge number of devices have recently come to be connected to networks with the rapid spread and expansion of the Internet of Things (IoT). It is said that more than 10 billion devices will be connected to the Internet by 2025. In the future, many devices will be installed in various environments such as homes, factories, and streets, and it is expected that various services using them will appear.

As an example of a service performed by using such a device, there is a service which collects information from the environment by using a sensor device and controls an actuator device on the basis of the information. Sensor devices are devices which acquire information from the environment such as cameras and temperature sensors. Actuator devices are devices which physically act on the environment such as speakers, lights, and displays.

Generally, a system composed of a plurality of devices arranged in such a physical space is affected by installation conditions and environmental changes, and thus control logic for cooperative operation becomes complicated. For example, in the control of a heater based on a temperature sensor installed in the environment, if a temperature sensor and a heater are distant from each other, it takes time for the output result of the heater to be reflected in a temperature at an observation point.

Therefore, it is necessary to adjust an output of the heater in consideration of the time until it is reflected.

Furthermore, to perform high-level control such as warming up only a place where a person is present, it is also necessary to detect and estimate a position of a person in real time by using a sensor in the vicinity.

As described above, the construction of a system for linking a plurality of devices has required a large amount of time and specialized design and verification in the related art, which is an obstacle to the inexpensive and prompt provision of services.

NPL 1 describes a tool called R-env: Linkage as an example of a system construction tool in which a plurality of devices are linked. The tool reduces the burden of a developer of the device linkage service by providing a function for absorbing interface differences between devices and a GUI tool for designing linkage scenarios. However, the detailed control logic of each device accompanying the linkage operation of the devices still requires manual design and pre-adjustment.

For example, a system which moves a robot to a target from a camera image may be conceived. It is necessary to design a control logic which obtains the position coordinates of the robot and the distance to the target on the basis of a captured image of the camera and further to design a control logic which calculates a movement direction and a speed of the robot for going to a target point. These control logics need to consider the environment in which an IoT device is placed such as a positional relationship between a camera and a robot and a size of a housing.

This environment varies variously depending on a combination of a huge number of installation positions and types. Therefore, it takes a lot of labor to manually handle all the logical design of IoT devices according to various environments.

On the other hand, NPL 2 describes, as a machine learning method, enhancement learning which improves a learning model to maximize a reward. The learning model is, for example, obtained by implementing a control logic which outputs an appropriate amount of robot movement according to a camera image on the basis of previous achievements.

Thus, since an appropriate learning model corresponding to the environment is automatically created and actuator control is performed by using the learning model, it is possible to reduce the time and effort for manually adjusting complicated control logic.

### CITATION LIST

### Non Patent Literature

[NPL 1] Takahiro MATSUMOTO, Narimune MATSUMURA, Takashi HOSOBUCHI, and the like, “R-env: Linkage TM” Cloud-Compatible Interaction Control Technology, “The 30th Annual Conference of the Japanese Society for Artificial Intelligence, 2016, 114-NFC-02b-1
[NPL 2] Aurelien Geron, “Practical Machine Learning with scikit-learn and TensorFlow,” O'Reilly Japan, April 2018

### SUMMARY OF INVENTION

### Technical Problem

It is difficult to apply general machine learning of NPL 2 or the like to an environment without reproducibility because the utility cannot be obtained if a difference between a learning model creation environment and a usage environment is large. For example, it is desirable that the installation position of a camera be fixed and the topography and obstacles not change to construct a system for moving a robot to a target by utilizing images captured by a plurality of cameras in the vicinity by machine learning. This is because, when the environment changes, it is necessary to perform learning covering all possible situations, and therefore it is necessary to collect a large amount of data over a long time.

On the other hand, future services are expected to be realized by combining various types of and positional relationship between devices connected to a network in various environments surrounding daily life. Therefore, when learning models created in the past are re-used in future services, there will be few future environments which completely reproduce the environments in previous learning.

In addition to the variety of device types and positional relationships which make up a system, it is also necessary to consider the variety of system operation environments such as outside air temperature, illuminance, and the presence or absence of shields. Therefore, the diversity of situations which can occur is enormous and it is costly and difficult to prepare a learning model which covers each of the various environments. None of the development tools in the related art of NPL 1 or the like considers the diversity of environments.

Therefore, a main object of the present invention is to efficiently construct a learning model for performing appropriate actuator control even in various environments.

### Solution to Problem

In order to solve the above problem, a device control apparatus of the present invention has the following features. The present invention relates to a device control apparatus which is disposed in a system operation environment and is connected to a sensor device and an actuator device by communication, and includes

a classification unit which refers to classification specification data associating a classification label from previous sensor information acquired from the sensor device in the past and assigns the classification label to sensor information of a current time acquired from the sensor device at a current time and,
a control unit which refers to model specification data obtained by associating the classification label with a learning model prepared in advance for each classification label, selects, as an enhancement model, a learning model corresponding to a classification label provided by the classification unit,
controls the actuator device using the enhancement model, and enhances and learns the enhancement model on the basis of sensor information acquired from the sensor device in accordance with the control.

### Advantageous Effects of Invention

According to the present invention, it is possible to efficiently construct a learning model for performing appropriate actuator control even in various environments.

### BRIEF DESCRIPTION OF DRAWINGS

FIG. 1 is a configuration diagram of a device control system according to an embodiment.

FIG. 2 is a hardware configuration diagram of a device control apparatus according to the embodiment.

FIG. 3 is a configuration diagram of a model table and a classification table according to the embodiment.

FIG. 4 is a configuration diagram of a model table and a classification table showing a state after enhancement learning of an existing model from FIG. 3 according to the embodiment.

FIG. 5 is a configuration diagram of a model table and a classification table showing a state after addition of a new model from FIG. 3 according to the embodiment.

FIG. 6 is a flowchart for describing a classification process performed by a classification unit according to the embodiment

FIG. 7 is a flowchart for describing a reclassification process performed by the classification unit, following FIG. 6 according to the embodiment.

FIG. 8 is a flowchart for describing an execution process of enhancement learning performed by a control unit according to the embodiment.

FIG. 9 is a flowchart for describing a post-enhancement learning process performed by the control unit, following FIG. 8 according to the embodiment.

FIG. 10 is a graph for describing details of determination processing of an evaluation value of a reward according to the embodiment.

### DESCRIPTION OF EMBODIMENTS

An embodiment of the present invention will be described in detail below with reference to the drawings.

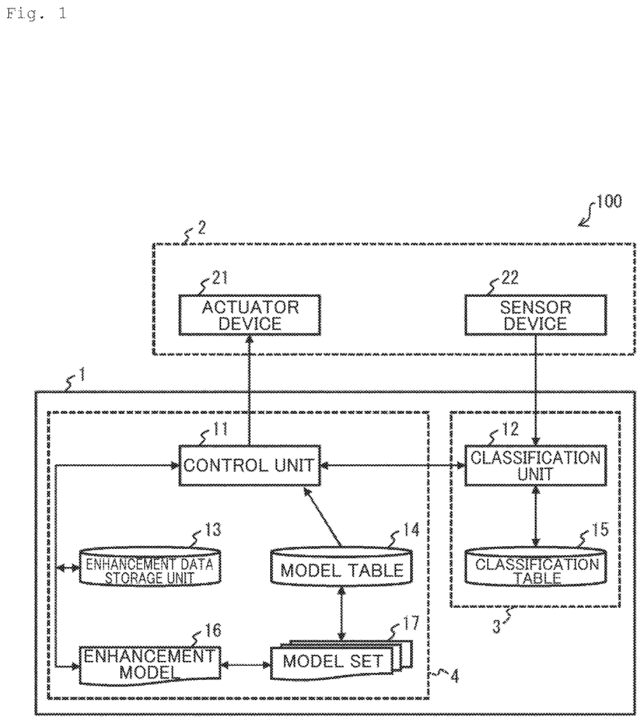

FIG. 1 is a configuration diagram of a device control system 100.

The device control system 100 is configured by connecting a system operation environment 2 in which one or more actuator devices 21 and one or more sensor devices 22 are arranged, and a device control apparatus 1 for controlling each device of the system operation environment 2 by a network.

The devices (actuator device 21 and sensor device 22) in the system operation environment 2 are connected over a network and can exchange information with each other.

The system operation environment 2 may vary even in the same physical space depending on at least one of the type of each device, the installation position (layout) of each device, and the environmental conditions at the installation position under the environment of the system operation environment 2. For example, the system operation environment 2 may be different from that before the change when the installation position (layout) of each device is changed even when the same device is disposed in the same room.

Furthermore, the system operation environment 2 may be different from the system operation environment 2 before the change when the environmental conditions change (for example, change from morning to night and change from summer to winter) even if the same device is disposed in the same room in the same layout.

Thus, it becomes easy to construct a highly accurate learning model specialized for each environment by diversifying the system operation environment 2.

The actuator device 21 is a device which is installed in the system operation environment 2 (indoors or the like) and acts in the system operation environment 2. For example, the actuator device 21 may be a device fixed in a room such as a speaker, a light, a display, an air conditioner, or the like, or a robot moving in a room.

The sensor device 22 is a device which is installed in the system operation environment 2 and obtains various data relating to the system operation environment 2 by measurement. For example, the sensor device 22 may be a camera which monitors the interior of a room or a temperature sensor which measures the temperature of the interior of the room. Furthermore, the actuator device 21 and the sensor device 22 may be integrated into the same housing.

Note that the “sensor information” relating to the sensor device 22 is one or more pieces of information which will be exemplified below.
Information indicating the sensor device 22 itself. For example, information indicating a model such as a model number which is a notification provided by the device.
Information defined by a relationship between the sensor device 22 and the system operation environment 2. For example, installation position information of a camera in the system operation environment 2 and field angle information of the camera are acquired when the sensor device 22 is the camera.
Measurement data output from the sensor device 22. For example, the sensor information is image data if the sensor device 22 is a camera. The sensor information is air temperature data if the sensor device 22 is a temperature sensor.

The device control apparatus 1 uses a “classification label” as an identifier for distinguishing a plurality of system operation environments 2. The classification labels include “existing labels” registered in the past and “new labels” newly issued this time.

The device control apparatus 1 includes a control unit 11, a classification unit 12, an enhancement data storage unit 13, a model table (model specification data) 14, a classification table (classification specification data) 15, an enhancement model 16, and a model set 17.

Note that the constituent elements of the device control apparatus 1 may be accommodated in one housing as shown in FIG. 1 or may be accommodated in a plurality of housings in a distributed manner. For example, the functions of the device control apparatus 1 may be provided in the environment classification apparatus 3 having the classification unit 12 and the classification table 15, and the actuator control apparatus 4 having the control unit 11, the enhancement data storage unit 13, the model table 14, the enhancement model 16, and the model set 17 in a distributed manner.

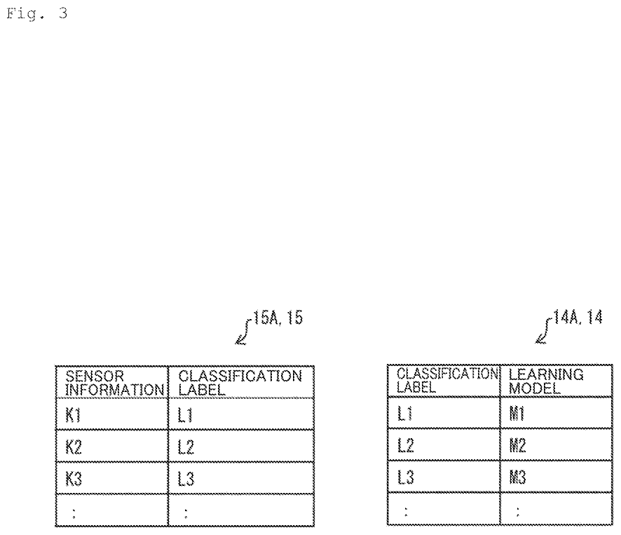

The classification unit 12 takes the sensor information from the sensor device 22 as an input and outputs a classification label corresponding to the sensor information with reference to the classification table 15 (details are shown in FIG. 3). Thus, the system operation environment 2 in which the sensor device 22 of the input sensor information operates is classified.

The control unit 11 receives the classification label from the classification unit 12, refers to the model table 14 (details are shown in FIG. 3), and selects a learning model corresponding to the classification label from the existing models registered as the model set 17.

The selected learning model is transferred (data copied) as the enhancement model 16 and used for controlling the actuator device 21. The enhancement model 16 takes the sensor information as an input and outputs a control amount of the actuator device 21 suitable for the sensor information. The control amount is, for example, combination information of a moving direction and a moving distance of the movable actuator device 21.

Furthermore, the control unit 11 stores the sensor information from the sensor device 22 which changes in accordance with the control result of the actuator device 21 as the enhancement data in the enhancement data storage unit 13 and performs the enhancement learning (improvement) on the enhancement model 16 on the basis of the enhancement data. The enhancement learning is a method of machine learning which derives behaviors called rewards which maximize an arbitrarily determined index value using a learning model created by repeatedly performing trials and is described in, for example, NPL 2.

That is to say, the enhancement learning is a method of mechanically (automatically) linking a state of the system operation environment 2 obtained from the sensor device 22 and a control value of the actuator device 21 as the enhancement model 16 by statistical data processing. Thus, the man-hours can be reduced as compared with the manual design of the control logic.

Furthermore, the amount of data required for learning is reduced compared with a case in which new learning is performed from a state in which there is no data, and an appropriate solution can be introduced by a small number of trials by starting enhancement learning after transferring the existing model to the enhancement model 16.

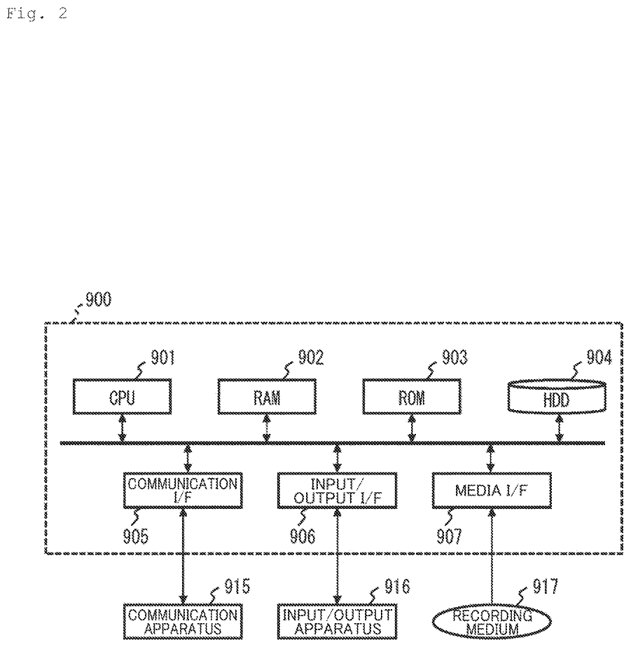

FIG. 2 is a hardware configuration diagram of the device control apparatus 1.

The device control apparatus 1 is configured as a computer 900 having a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output apparatus 916. The media I/F 907 reads and writes data from and to a recording medium 917.

Furthermore, the CPU 901 controls each processing unit by executing a program (also referred to as an application or an abbreviation thereof) read into the RAM 902. Also, this program can also be distributed through a communication line or recorded and distributed on the recording medium 917 such as a CD-ROM.

The processing outline of the device control apparatus 1 will be described below with reference to FIGS. 3 to 5.

FIG. 3 is a block diagram of the model table 14 and the classification table 15.

The classification table 15 is a table for the classification unit 12 to obtain a classification label from the sensor information. The model table 14 is a table for the control unit 11 to obtain a learning model (existing model of the model set 17) from the classification label.

Note that the model table 14 and the classification table 15 are shown as correspondence tables, respectively. However, the correspondence table is a data format for making the description easy to understand, and an arbitrary data format for obtaining the corresponding output information from the input information may be adopted.

For example, when the sensor information is an image, the classification result (classification label) of the image can be obtained by an image classification function using a convolutional neural network (CNN) or the like instead of the classification table 15.

Furthermore, the classification unit 12 collates the sensor information “K21” input this time with the sensor information “K1, K2, K3, . . . ” registered in the classification table 15 and obtains a “similarity” that is an index showing how similar each of pieces of sensor information are.

When the sensor information is image data, the similarity can be calculated as a quantitative value by comparing feature quantities obtained from the sensor information such as the arrangement of hue of the image and the position of feature points in the image with each other.

It is assumed that the similarity which will be exemplified below is a score from the most dissimilar “0” to the same “100” and the higher the score, the more similar the sensor information is.
Similarity between the sensor information “K21” and the sensor information “K1”=90
Similarity between the sensor information “K21” and the sensor information “K2”=80
Similarity between the sensor information “K21” and the sensor information “K3”=20

The classification unit 12 adopts the sensor information “K1” for which the maximum similarity “90” is calculated and notifies the control unit 11 of a classification result signal including a classification label “L1” corresponding to the “K1”. The control unit 11 inputs the notified classification label “L1” to the model table 14 and obtains a corresponding learning model “M1” from the existing model of the model set 17. Note that the model table 14 associates each classification label with one learning model.

The control unit 11 transfers the learning model “M1” as the enhancement model 16 and starts enhancement learning. However, the reward of the enhancement learning of the learning model “M1” does not increase so much and the enhancement model 16 cannot be optimized to the system operation environment 2 of the sensor information “K21”. Thus, the control unit 11 returns a re-classification request signal indicating that the learning model “M1” is erroneous to the classification unit 12.

The classification unit 12 receives the re-classification request signal, adopts the sensor information “K2” obtained by calculating the similarity “80” of the next point, and notifies the control unit 11 of the corresponding classification label “L2”.

The control unit 11 inputs the notified classification label “L2” to the model table 14 and obtains a corresponding learning model “M2” from the existing model of the model set 17. The control unit 11 starts enhancement learning using the learning model “M2” as the enhancement model 16. The enhancement learning of the learning model “M2” succeeds because the reward significantly increases this time. Thus, the control unit 11 returns a classification determination signal indicating that the learning model “M2” is correct to the classification unit 12.

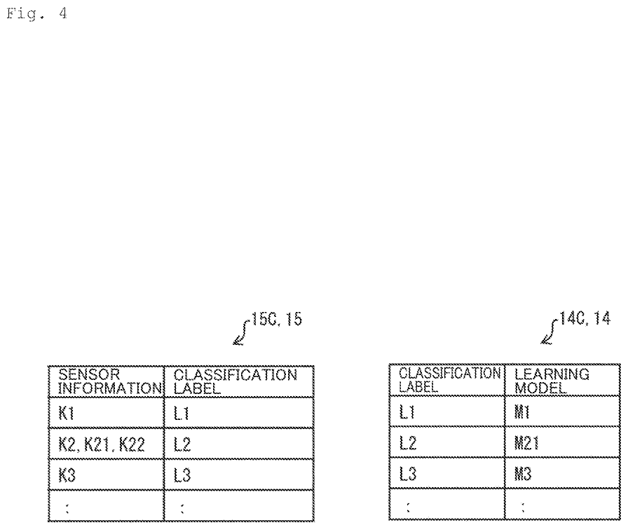

FIG. 4 is a block diagram of the model table 14 and the classification table 15 showing the state after the enhancement learning of the existing model from FIG. 3.

The classification unit 12 receives the classification determination signal and updates the classification table 15 so that the sensor information “K22” used during the enhancement learning and stored in an enhancement data storage unit 13 is associated with the classification label “L2” in addition to the sensor information “K21” before the enhancement learning of this time. Therefore, the classification determination signal includes the sensor information “K22”.

The control unit 11 updates a learning model “M2” before enhancement learning read from the model set 17 to a learning model “M21” after enhancement learning as the enhancement model 16. That is to say, the learning model “M2” of the model set 17 is replaced with the learning model “M21”.

Furthermore, the control unit 11 reflects the replaced learning model “M21” also in the model table 14. Thus, since the learning model “M21” after the enhancement learning can be utilized from the next time, the time of the enhancement learning can be shortened.

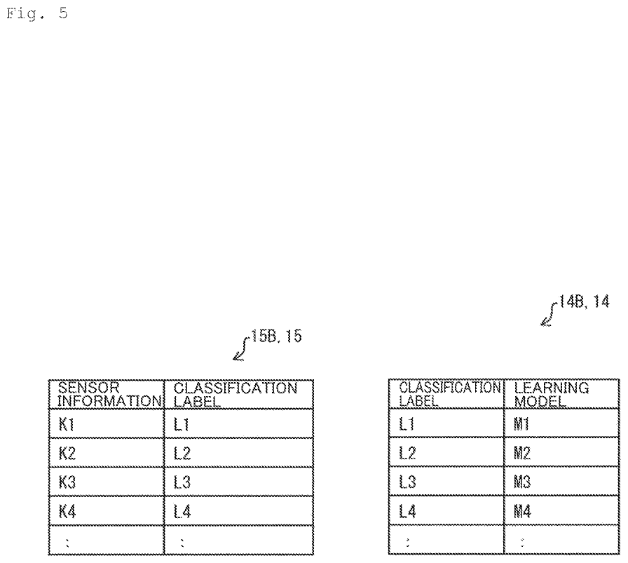

FIG. 5 is a block diagram of the model table 14 and the classification table 15 showing the state after the addition of a new model from FIG. 3. Although an example of updating an existing model corresponding to an existing label has been described with reference to FIG. 4, an example of generating a new label and a new model will be described with reference to FIG. 5.

The classification unit 12 collates the sensor information “K4” input this time with the sensor information “K1, K2, K3, . . . ” registered in the classification table 15 to obtain the following similarity.
Similarity between the sensor information “K4” and the sensor information “K1”=40
Similarity between the sensor information “K3” and the sensor information “K2”=20
Similarity between the sensor information “K2” and the sensor information “K3”=10

In this case, the sensor information “K4” input this time is dissimilar to any entry in the classification table 15 (for example, less than the threshold value “50” of similarity). Thus, the classification unit 12 creates a new label “L4” for the sensor information “K4” input this time, registers it in the classification table 15, and includes it in the classification result signal to notify the control unit 11 of the fact.

Since the notified new label “L4” is not registered in the model table 14, the control unit 11 creates a new model “M4” corresponding to the new label “L4” from the state of blank sheet (unlearned) and sets it as an enhancement model 16. Furthermore, the enhancement model 16 (learning model “M4”) after the enhancement learning is registered in the model set 17 as an existing model.

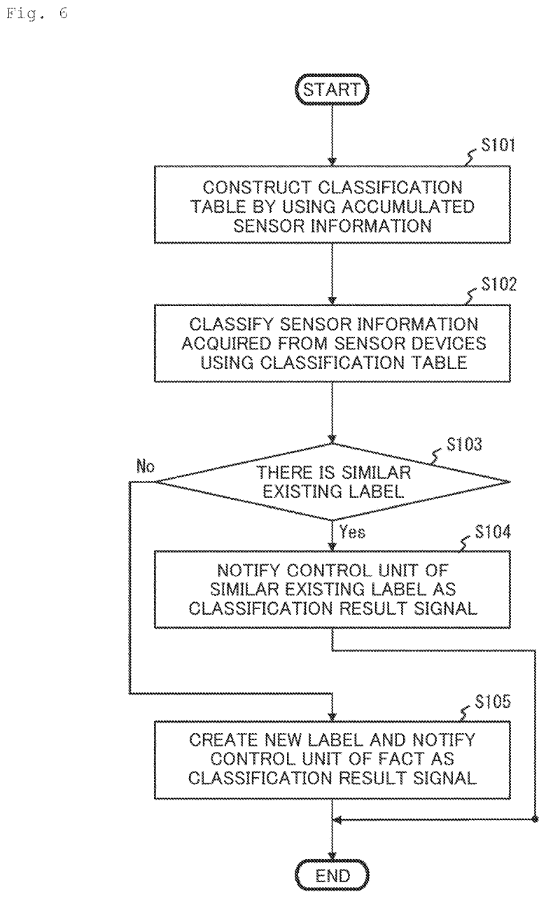

The outline of the processing of the device control apparatus 1 has been described above with reference to FIGS. 3 to 5. The processing of the device control apparatus 1 will be described in detail below with reference to FIG. 6.

FIG. 6 is a flowchart for describing a classification process performed by the classification unit 12.

The classification unit 12 adds a classification label to sensor information accumulated in the past for each system operation environment 2 to construct the classification table 15 (S101). The classification unit 12 receives the sensor information of this time from a new sensor device 22 (or a manager thereof) as a system configuration request and classifies the sensor information of this time by using a classification table 15 (S102).

The classification unit 12 determines whether or not an existing label (similarity of 50 or more) similar to the sensor information of this time exists in the classification table 15 as the classification result of S102 (S103). If Yes is determined in S103, the process proceeds to S104, and if No is determined, the process proceeds to S105.

In S104, the classification unit 12 notifies the control unit 11 of the existing label having the highest similarity as a classification result signal.

In S105, the classification unit 12 creates a new label and notifies the control unit 11 as a classification result signal.

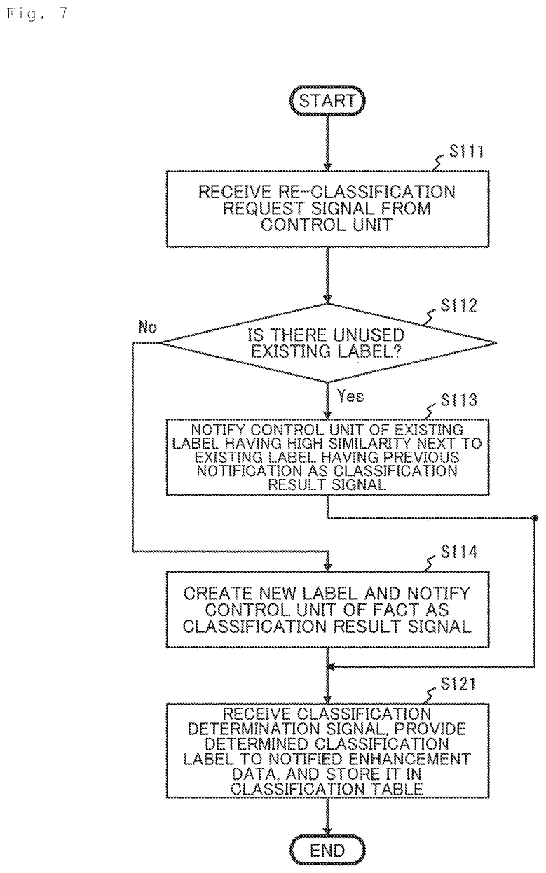

FIG. 7 is a flowchart for describing a reclassification process performed by the classification unit 12 following FIG. 6.

The classification unit 12 receives a re-classification request signal indicating that the classification label transmitted by the previous classification result signal is an error from the control unit 11 (S111). The classification unit 12 determines whether or not there is an unused (that is, not yet notified as the classification result) existing label in the classification result signal (S112). If Yes is determined in S112, the process proceeds to S113, and if No is determined, the process proceeds to S114.

In the case of Yes in S112, the classification unit 12 notifies the control unit 11 of an existing label having a high similarity next to the existing label classified last time as a classification result signal (S113).

In the case of No in S112, as a result of repeatedly performing the determination of the classification error, it is determined that the learning model cannot be constructed even though the learning model corresponding to all the existing labels is applied. At that time, the classification unit 12 creates a new label indicating the system operation environment 2 of this time and notifies the control unit 11 as a classification result signal.

Furthermore, when a classification determination signal that is a notification from the control unit 11 is provided to the classification result signal of S113 or S114, the classification unit 12 stores a result of assigning a determined classification label to sensor information (enhancement data) included in the classification determination signal in the classification table 15 (S121).

That is to say, all of the sensor information collected and used by the control unit 11 after classification are associated with the classification label to which the classification determination signal is notified, in addition to the sensor information used for classification. Thus, when a new system configuration request is received, the same classification error as in the previous system configuration request can be prevented.

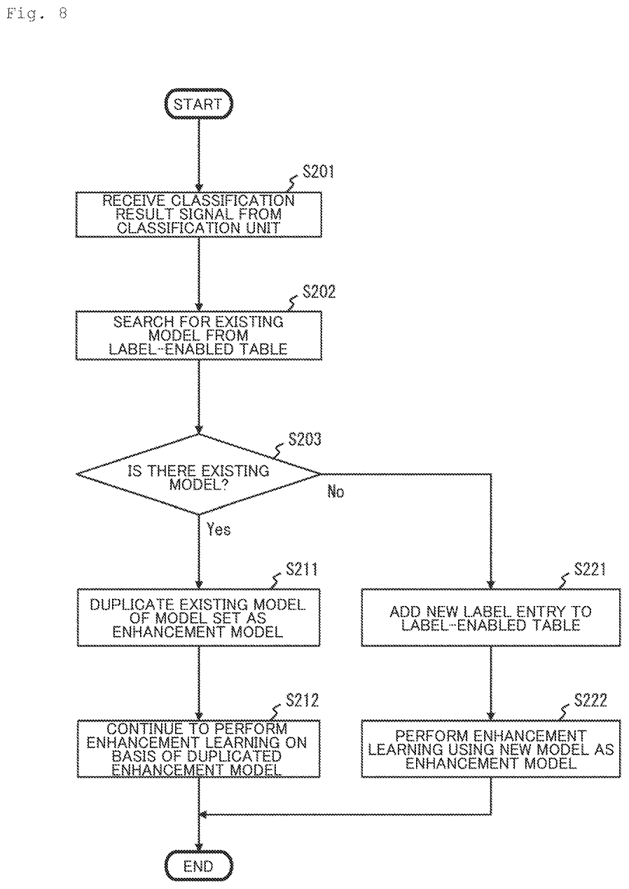

FIG. 8 is a flowchart for describing an execution process of enhancement learning performed by the control unit 11.

When the control unit 11 receives the classification result signal from the classification unit 12 (S201), the control unit 11 searches the model table 14 for the corresponding existing model using the classification label of the classification result signal as an input (S202).

The control unit 11 determines whether or not an existing model exists (S203). If YES is determined in S203, the process proceeds to S211, and if No is determined, the process proceeds to S221.

In the case of Yes in S203, the control unit 11 duplicates the existing model of the model set 17 retrieved in S202 as the enhancement model 16 (S211) and controls the actuator by inputting the sensor information to the enhancement model 16. Furthermore, the control unit 11 continuously performs enhancement learning on the basis of the duplicated enhancement model 16 (S212).

In the case of No in S203, the control unit 11 adds an entry (corresponding new model) corresponding to the new label to the model table 14 (S221). The new model is a blank model (unlearned model) that does not depend on any system operating environment 2. The control unit 11 performs enhancement learning by using a new model without prior information as the enhancement model 16 (S222).

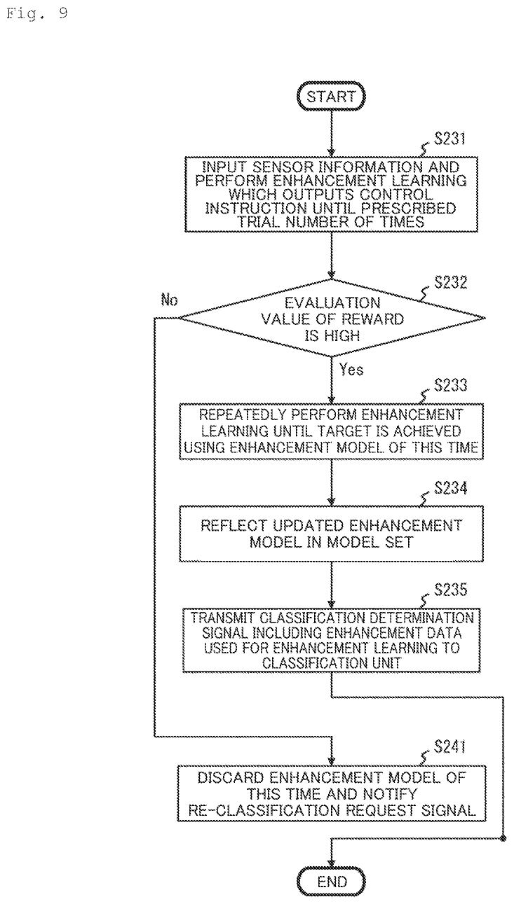

FIG. 9 is a flowchart for describing the post-enhancement learning process performed by the control unit 11 following FIG. 8.

The control unit 11 inputs the sensor information from the sensor device 22 to the enhancement model 16 and performs enhancement learning (S212 or S222 in FIG. 8) to output a control instruction to the actuator device 21 until a prescribed trial number of times (S231). The control unit 11 updates the enhancement model 16 at any time to increase the reward of the enhancement model 16 every time the enhancement learning is performed. Note that, during the execution of the enhancement learning, the control unit 11 stores all of the collected sensor information in the enhancement data storage unit 13.

The control unit 11 determines whether or not an evaluation value of the reward is higher than a predetermined threshold value (S232). If Yes is determined in S232, the process proceeds to S233, and if No is determined, the process proceeds to S241. Note that, when new enhancement learning is performed from a new model corresponding to a new label (S222 in FIG. 8), unlike the case in which the enhancement learning is performed by transferring an existing model corresponding to an existing label, the determination in S232 is omitted and the processing is advanced to S233.

In addition, a plurality of triggers for determining S232 may be set. For example, a plurality of combinations of the number of trials to be determined and a predetermined threshold value may be prepared and the learning may be determined stepwise during the continuation of the learning.

The case of No in S232 is a case in which a learning model which achieves the purpose of the service provided by the actuator device 21 cannot be constructed in the system operation environment 2.

In this case, the control unit 11 considers that the selection of the enhancement model 16 (classification label) of this time is incorrect and discards it and notifies the classification unit 12 of the reclassification request signal to which the classification label is added (S241).

Note that, even when it is determined in S241 that the classification is incorrect and the learning model to be used is changed, the sensor information collected up to that point in the enhancement data storage unit 13 is inherited to the learning model to be applied next.

In the case of Yes in S232, the control unit 11 repeatedly performs the enhancement learning in the enhancement model 16 of this time until the purpose of the service is achieved since correct classification is performed (S233). For example, the control unit 11 determines whether or not the purpose of the service is achieved on the basis of the evaluation value of the reward of the enhancement learning in the trial of a fixed number of times, as in the determination of S232.

When the purpose of the service is finally achieved, the control unit 11 ends the enhancement learning. Furthermore, the control unit 11 replaces the enhancement model 16 updated by the enhancement learning using a learning model of a duplication source in the model set 17 and thus reflects the enhancement model 16 in the model set 17 (S234).

The control unit 11 transmits a classification determination signal including the classification label used for the enhancement learning and the enhancement data (sensor information) of the enhancement data storage unit 13 used for the enhancement learning to the classification unit 12 (S235). The enhancement data transmitted by the classification determination signal may include enhancement data at the time of classification error inherited in S241.

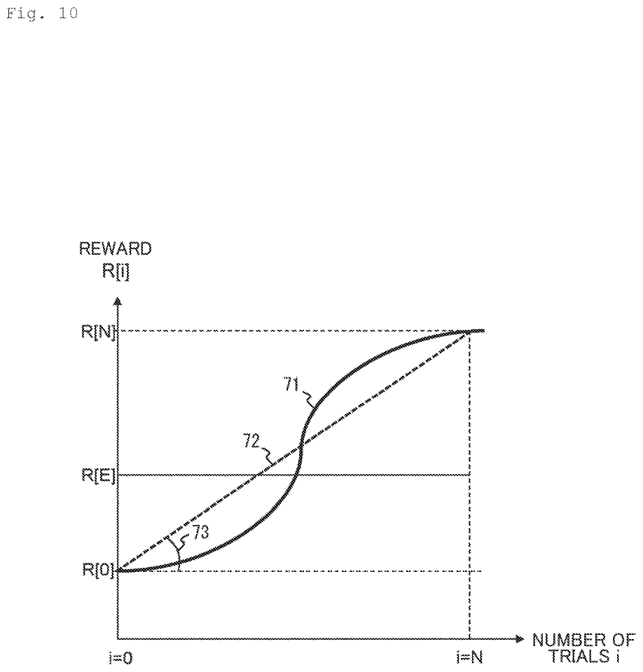

FIG. 10 is a graph for describing the details of the processing for determining the evaluation value of the reward (S232 in FIG. 9).

The horizontal axis of the graph is the number of trials i of enhancement learning, the left end is before the trial (i=0), and the right end is the specified number of trials in S231 (i=N). The vertical axis of the graph is a reward R[i] in the i-th trial and the result of this trial is indicated by a curve 71.

As illustrated in the following Method 1 or Method 2, the control unit 11 uses the statistic of the acquired reward R[i] to determine whether or not the evaluation value of the reward is high (S232, Yes) (S232, No) is determined. The reward is an index indicating the evaluation of behavior in the enhancement learning and is an indispensable element for implementing enhancement learning.

(Method 1): When an average value R[E] of the reward R[i] from i=0 to i=N is higher than a predetermined threshold value, an evaluation value of the reward is high (S232, Yes). The average value R[E]=(R[0]+R[1]+ . . . R[N])/(N+1). Thus, the effectiveness of the adopted learning model can be evaluated by the absolute amount of the reward.

(Method 2): When a differential coefficient of the reward from i=0 to i=N of the reward R[i] (slope 73 of a straight line 72) is higher than a predetermined threshold value, an evaluation value of the reward is high (S232, Yes). Thus, the effectiveness of the adopted learning model can be evaluated by the degree of increase of the reward.

[Effects]

The present invention relates to a device control apparatus 1 which is disposed in a system operation environment 2 and is connected to a sensor device 22 and an actuator device 21 by communication, which includes

a classification unit 12 which refers to classification table 15 associating a classification label from previous sensor information acquired from the sensor device 22 in the past and assigns the classification label to sensor information of this time acquired from the sensor device 22 this time and, a control unit 11 which refers to a model table 14 obtained by associating the classification label with a learning model prepared in advance for each classification label, selects, as an enhancement model 16, a learning model corresponding to a classification label provided by the classification unit 12, controls the actuator device 21 using the enhancement model 16, and enhances and learns the enhancement model 16 on the basis of sensor information acquired from the sensor device 22 in accordance with the control.

Also, the present invention relates to an environment classification apparatus 3 and an actuator control apparatus 4 for constituting the device control apparatus 1.

Thus, an appropriate learning model can be determined from the sensor information and the learning model can be enhancement-learned by using the sensor information related to each similar environment. Thus, it is possible to derive appropriate actuator control according to each environment from a small amount of learning data by dividing the learning space of machine learning for each environment and generating a learning model specialized for each environment. Furthermore, an appropriate number of classification labels can be automatically generated without manually grasping the subtleties of device installation positions and environmental differences. Furthermore, it is not necessary to prepare comprehensive learning data in advance, special hardware is not required, and it can be implemented only by software functions.

In the present invention, the classification unit 12 updates the classification table 15 by adding a new label, which is a newly issued classification label, to the sensor information of this time when the previous sensor information having a similarity of a predetermined value or more to the sensor information of this time and are not registered in the classification table 15, and

the control unit 11 selects the learning model in the unlearned state as the enhancement model 16 and updates the model table 14 by associating the enhancement model 16 with the new label.

This can prevent an inappropriate existing model from being accidentally adopted in the system operation environment of this time. Note that the application of an existing model constructed in a significantly different environment to a new environment which has not been treated so far induces inappropriate control and prevents achievement of learning.

In the present invention, the control unit 11 determines that the classification label corresponding to the enhancement model 16 used this time is an error and transmits a re-classification request signal to the classification unit 12 when an evaluation value of a reward as a result of enhancement learning of the enhancement model 16 is less than a predetermined threshold value, and

the classification unit 12 receives the re-classification request signal, reads a classification label which has not yet been assigned to the sensor information of this time from the classification table 15, and assigns the read classification label to the sensor information of this time.

This makes it possible to reselect the correct learning model even when the selection of the learning model to be transferred is incorrect.

In the present invention, the control unit 11 notifies the classification unit 12 of the sensor information used for the enhancement learning of the enhancement model 16 as enhancement data when a degree of increase in reward as a result of enhancement learning of the enhancement model 16 is equal to or more than a predetermined threshold value and stores the enhancement model 16 of this time as a learning model corresponding to the same classification label of the next time, and

the classification unit 12 updates the classification table 15 so that the sensor information of the notified enhancement data is associated with the classification label of this time.

Thus, when a new system configuration request is received, the same classification error as the previous system configuration request can be prevented.

### REFERENCE SIGNS LIST

1 Device control apparatus
2 System operation environment
3 Environment classification apparatus
4 Actuator control apparatus
11 Control unit (actuator control apparatus)
12 Classification unit (environment classification apparatus)
13 Enhancement data storage unit
14 Model table (model specification data)
15 Classification table (classification specification data)
16 Enhancement model
17 Model set (learning model)
21 Actuator device
22 Sensor device
100 Device control system

1. A device control apparatus disposed in a system operation environment and operably connected to a sensor device and an actuator device, comprising:
a classification unit, implemented using one or more computing devices, configured to:
refer to classification specification data associating a classification label from previous sensor information acquired from the sensor device, and
assign the classification label to current sensor information acquired from the sensor device; and
a control unit, implemented using one or more computing devices, configured to:
refer to model specification data obtained by associating the classification label with a learning model prepared in advance for each classification label,
select, as an enhancement model, a learning model corresponding to the classification label provided by the classification unit based on the model specification data,
control the actuator device using the enhancement model, and
enhance and learn the enhancement model based on the current sensor information acquired from the sensor device in accordance with the control.

2. The device control apparatus according to claim 1,
wherein the classification unit is configured to:
update the classification specification data by adding a new label, which is a newly issued classification label, to the current sensor information based on previous sensor information having a similarity of a predetermined value or more to the current sensor information and not being registered in the classification specification data, and
wherein the control unit is configured to:
select a learning model in an unlearned state as the enhancement model, and
update the model specification data by associating the enhancement model with the new label.

3. The device control apparatus according to claim 1,
wherein the control unit is configured to:
determine that the classification label corresponding to the enhancement model is an error, and
transmit, based on an evaluation value of a reward as a result of enhancement learning of the enhancement model being less than a predetermined threshold value, transmits a re-classification request signal to the classification unit, and
wherein the classification unit is configured to:
receive the re-classification request signal,
read a classification label which has not yet been assigned to the current sensor information from the classification specification data, and
assign the read classification label to the current sensor information.

4. The device control apparatus according to claim 1,
wherein the control unit is configured to:
notify, based on a degree of increase in reward as a result of enhancement learning of the enhancement model being equal to or greater than a predetermined threshold value, the classification unit of the sensor information used for the enhancement learning of the enhancement model as enhancement data, and
store the enhancement model as a learning model corresponding to the same classification label, and
wherein the classification unit is configured to update the classification specification data so that the sensor information of the notified enhancement data is associated with the classification label.

5. (canceled)

6. An environment classification apparatus disposed in a system operation environment and operably connected to a sensor device and an actuator device, comprising:
a classification unit, implemented using one or more computing devices, configured to:
specify a learning model used for controlling the actuator device from a learning model prepared in advance for each classification label by referring to classification specification data associating a classification label from previous sensor information acquired from the sensor device and assigning the classification label to current sensor information acquired from the sensor device.

7. An actuator control apparatus disposed in a system operation environment and operably connected to a sensor device and an actuator device, comprising:
a control unit, implemented using one or more computing devices, configured to:
control the actuator device by using an enhancement model which is a learning model specified from current sensor information acquired from the sensor device, and
perform enhancement learning of the enhancement model based on the current sensor information acquired from the sensor device in accordance with the control.
